(19) United States
(12) Patent Application Publication
(10) Pub. No.: US 2024/0126828 A1
(43) Pub. Date: Apr. 18, 2024

(54) COMPUTER-READABLE RECORDING MEDIUM STORING DETECTION PROGRAM, DETECTION METHOD, AND DETECTION APPARATUS

(71) Applicant: Fujitsu Limited, Kawasaki-shi (JP)

(72) Inventor: Hiroaki KURIHARA, Chigasaki (JP)

(73) Assignee: Fujitsu Limited, Kawasaki-shi, Kanagawa (JP)

(21) Appl. No.: 18/227,307

(22) Filed: Jul. 28, 2023

(30) Foreign Application Priority Data
Oct. 12, 2022 (JP) 2022-163915

(51) Int. Cl. G06F 17/11

(52) U.S. Cl. CPC G06F 17/11

(57) ABSTRACT

A non-transitory computer-readable recording medium stores a detection program for causing a computer to execute a process. In the process, the computer generates weighted graph structure data for a plurality of pieces of time-series data, with a partial correlation specified based on a matrix calculated by solving an optimization problem about a precision matrix for the plurality of pieces of time-series data, as a weight of a side in a graph; and detects a sign of an anomaly, based on distribution of data points in a predetermined region in a persistence diagram obtained by a persistent homology transformation for the weighted graph structure data.

### CROSS-REFERENCE TO RELATED APPLICATION

This application is based upon and claims the benefit of priority of the prior Japanese Patent Application No. 2022-163915, filed on Oct. 12, 2022, the entire contents of which are incorporated herein by reference.

### FIELD

The embodiments discussed herein are related to a detection program, a detection method, and a detection apparatus.

### BACKGROUND

When a plurality of pieces of time-series data is obtained, it is known to monitor a system or detect an anomaly by focusing on a relationship between these pieces of time-series data.

The time-series data is, for example, data having information according to a lapse of time, such as a voltage, a frequency, a rotation speed, and a pressure of a certain system, supposed to represent a state for a certain period of time.

Examples of a data analysis approach based on a relationship between elements (pieces of time-series data) of a sequence of a plurality of pieces of time-series data include an approach using sparse structure learning. In this approach, a graph is prepared from a relationship between elements, using an optimization approach, and it is deemed that an anomaly has occurred in the system when the structure of the graph is greatly changed.

U.S. Patent Application Publication No. 2021/0209870, U.S. Patent Application Publication No. 2021/0067401, Japanese Laid-open Patent Publication No. 2019-105871, and International Publication Pamphlet No. WO 2018/220813 are disclosed as related art.

Ide, Tsuyoshi, “Sparse structure learning for correlation anomaly detection”, Proceedings of The Second Class Special Interest Group, The Japanese Society for Artificial Intelligence, Mar. 3, 2009, Volume 2009, DMSM-A803-04 is also disclosed as related art.

### SUMMARY

According to an aspect of the embodiments, a non-transitory computer-readable recording medium storing a detection program for causing a computer to execute a process including: generating weighted graph structure data for a plurality of pieces of time-series data, with a partial correlation specified based on a matrix calculated by solving an optimization problem about a precision matrix for the plurality of pieces of time-series data, as a weight of a side in a graph; and detecting a sign of an anomaly, based on distribution of data points in a predetermined region in a persistence diagram obtained by a persistent homology transformation for the weighted graph structure data . . . .

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a functional configuration of a detection device as an example of an embodiment;

FIG. 2 is a block diagram illustrating a hardware (HW) configuration example of a computer that implements the functions of the detection device according to one embodiment;

FIG. 3 is a diagram for explaining a graph in the detection device as an example of the embodiment;

FIG. 4 is a diagram illustrating an example of a weighted graph in the detection device as an example of the embodiment;

FIG. 5 is a diagram illustrating an example of a persistence diagram in the detection device as an example of the embodiment;

FIG. 6 is a diagram for explaining processing by an anomaly sign detection unit of the detection device as an example of the embodiment; and

FIG. 7 is a flowchart for explaining processing in the detection device as an example of the embodiment.

### DESCRIPTION OF EMBODIMENTS

In existing data analysis approaches as mentioned above using sparse structure learning, only determination of “normal” or “anomaly” is performed. However, in such a binary classification of “normal” and “anomaly”, when the state of the system is deemed to be “anomaly”, some sort of failure or fault has already happened in the system, and it is not feasible to find the occurrence of the failure or the like in advance.

In addition, it is also suspected that the detected “anomaly” is likely to be erroneous recognition that has been accidentally detected due to data noise or the like, and the reliability is low.

In one aspect, an object of the embodiments is to find a sign of an anomaly, based on a plurality of pieces of time-series data.

Hereinafter, embodiments relating to the present detection program, detection method, and detection device will be described with reference to the drawings. Note that the embodiments to be described below are merely examples, and there is no intention to exclude application of various modifications and techniques not explicitly described in the embodiments. For example, the present embodiments may be variously modified and carried out in a range without departing from the spirit of the embodiments. In addition, each drawing is not intended to include only constituent elements illustrated in the drawings and may include another function or the like.

### (A) Configuration

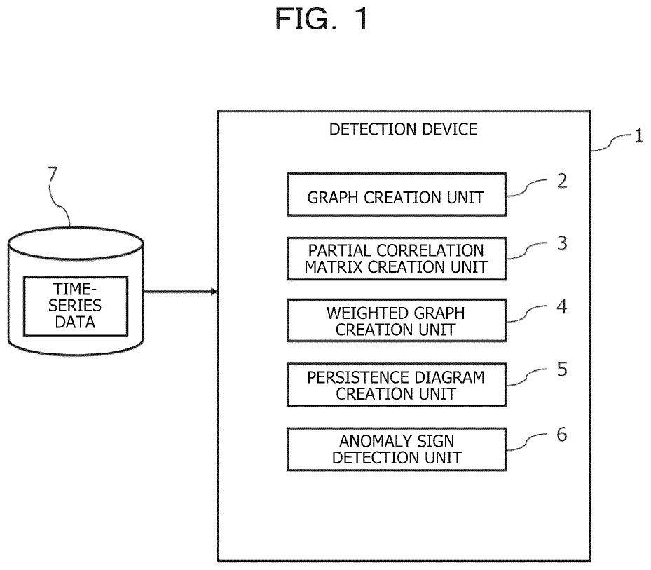

FIG. 1 is a diagram schematically illustrating a functional configuration of a detection device 1 as an example of an embodiment.

The detection device 1 analyzes a plurality of pieces of time-series data measured in an analysis object. The detection device 1 extracts a relationship between elements (pieces of time-series data) from the sequence of this plurality of pieces of time-series data, tracks a change in the state of the analysis object, and detects a sign of anomaly. The analysis object may be any system.

The time-series data may be acquired by a measurement device (not illustrated) measuring an analysis object. The time-series data measured by the measurement device is stored in a storage device 7 coupled to the detection device 1.

Note that a measurement device may be coupled to the detection device 1, and the time-series data may be input to the detection device 1 from this measurement device. The detection device 1 may analyze the time-series data input from the measurement device.

### (A-1) Hardware Configuration Example

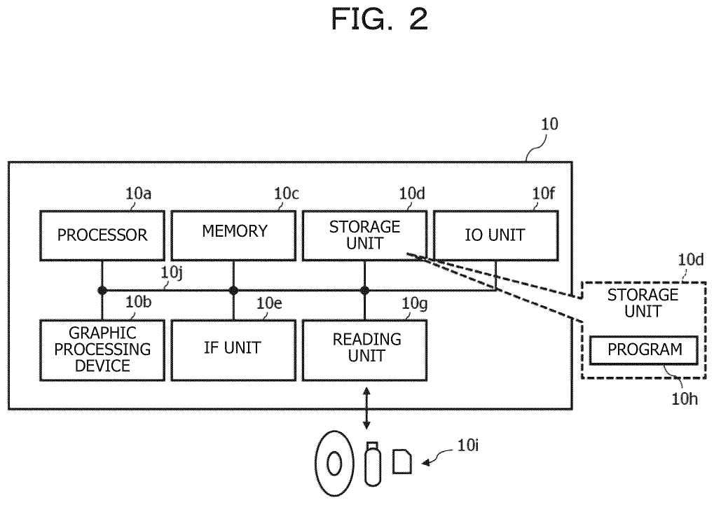

FIG. 2 is a block diagram illustrating a hardware (HW) configuration example of a computer 10 that implements the functions of the detection device 1 according to one embodiment. When a plurality of computers is used as the HW resources that implement the functions of the detection device 1, each computer may have the HW configuration depicted as one example in FIG. 2.

As illustrated in FIG. 2, the computer 10 may include, in one example, a processor 10a, a graphic processing device 10b, a memory 10c, a storage unit 10d, an interface (IF) unit 10e, an input/output (IO) unit 10f, and a reading unit 10g as the HW configuration.

The processor 10a is an example of an arithmetic processing device that performs various sorts of control and operations and is a control unit that executes various sorts of processing. The processor 10a may be coupled to each block in the computer 10 by a bus 10j so as to be able to communicate with each other. Note that the processor 10a may be a multi-processor including a plurality of processors, or a multi-core processor including a plurality of processor cores, or may have a configuration including a plurality of multi-core processors.

As the processor 10a, for example, an integrated circuit (IC) such as a CPU, an MPU, an APU, a DSP, an ASIC, or an FPGA is exemplified. Note that a combination of two or more of these integrated circuits may be used as the processor 10a. The CPU is an abbreviation for a central processing unit, and the MPU is an abbreviation for a micro processing unit. The APU is an abbreviation for an accelerated processing unit. The DSP is an abbreviation for a digital signal processor, the ASIC is an abbreviation for an application specific IC, and the FPGA is an abbreviation for a field-programmable gate array.

The graphic processing device 10b performs screen display control on an output device such as a monitor in the IO unit 10f. As the graphic processing device 10b, various arithmetic processing devices including, for example, an integrated circuit (IC) such as a graphics processing unit (GPU), an APU, a DSP, an ASIC, or an FPGA are exemplified.

The memory 10c is an example of HW that stores information such as various sorts of data and programs. As the memory 10c, for example, one or both of a volatile memory such as a dynamic random access memory (DRAM) and a nonvolatile memory such as a persistent memory (PM) are exemplified.

The storage unit 10d is an example of HW that stores information such as various sorts of data and programs. As the storage unit 10d, various types of storage devices including a magnetic disk device such as a hard disk drive (HDD), a semiconductor drive device such as a solid state drive (SSD), a nonvolatile memory, and the like are exemplified. As the nonvolatile memory, for example, a flash memory, a storage class memory (SCM), a read only memory (ROM), and the like are exemplified.

The storage unit 10d may store a program 10h (detection program) that implements all or a part of various types of functions of the computer 10.

For example, the processor 10a of the detection device 1 can implement a time-series data analysis function to be described later by loading the program 10h stored in the storage unit 10d into the memory 10c and executing the loaded program 10h. In addition, the storage unit 10d may function as the storage device 7 illustrated in FIG. 1.

The IF unit 10e is an example of a communication IF that performs, for example, control of coupling and communication between the present computer 10 and another computer. For example, the IF unit 10e may include an adapter conforming to a local area network (LAN) such as Ethernet (registered trademark), optical communication such as a fibre channel (FC), or the like. The adapter may support one or both of wireless and wired communication schemes.

For example, the detection device 1 may be coupled to the storage device 7 depicted as one example in FIG. 1, a measurement device (not illustrated), another information processing device, or the like via the IF unit 10e and a network so as to be able to communicate with each other. Note that the program 10h may be downloaded from the network to the computer 10 via the communication IF and stored in the storage unit 10d.

The IO unit 10f may include one or both of an input device and an output device. As the input device, for example, a keyboard, a mouse, a touch panel, and the like are exemplified. As the output device, for example, a monitor, a projector, a printer, and the like are exemplified. In addition, the IO unit 10f may include a touch panel or the like in which the input device and a display device are integrated. The output device may be coupled to the graphic processing device 10b.

The reading unit 10g is an example of a reader that reads information on data and programs recorded in a recording medium 10i. The reading unit 10g may include a coupling terminal or device to which the recording medium 10i can be coupled or inserted. As the reading unit 10g, for example, an adapter conforming to a universal serial bus (USB) or the like, a drive device that accesses a recording disk, a card reader that accesses a flash memory such as a secure digital (SD) card, and the like are exemplified. Note that the program 10h may be stored in the recording medium 10i, and the reading unit 10g may read the program 10h from the recording medium 10i and store the read program 10h in the storage unit 10d.

As the recording medium 10i, in one example, a non-transitory computer-readable recording medium such as a magnetic disk or an optical disc or a flash memory is exemplified. As the magnetic disk or an optical disc, in one example, a flexible disk, a compact disc (CD), a digital versatile disc (DVD), a Blu-ray disc, a holographic versatile disc (HVD), and the like are exemplified. As the flash memory, in one example, a semiconductor memory such as a USB memory or an SD card is exemplified.

The HW configuration of the computer 10 described above is an example. Therefore, an increase or decrease in the HW (for example, addition or deletion of an optional block), division, integration in an optional combination, addition or deletion of the bus, or the like in the computer 10 may be appropriately performed.

### (A-2) Functional Configuration Example

As illustrated in FIG. 1, in one example, the detection device 1 may have functions as a graph creation unit 2, a partial correlation matrix creation unit 3, a weighted graph creation unit 4, a persistence diagram creation unit 5, and an anomaly sign detection unit 6. These functions may be implemented by the hardware (the processor 10a: the control unit) of the computer 10 (see FIG. 2).

The graph creation unit 2 creates a graph representing a relationship between a plurality of pieces of time-series data, based on this plurality of pieces of time-series data. The time-series data may be simply referred to as data.

The graph creation unit 2 reads a plurality of pieces of time-series data stored in the storage device 7 and creates a graph based on this plurality of pieces of time-series data.

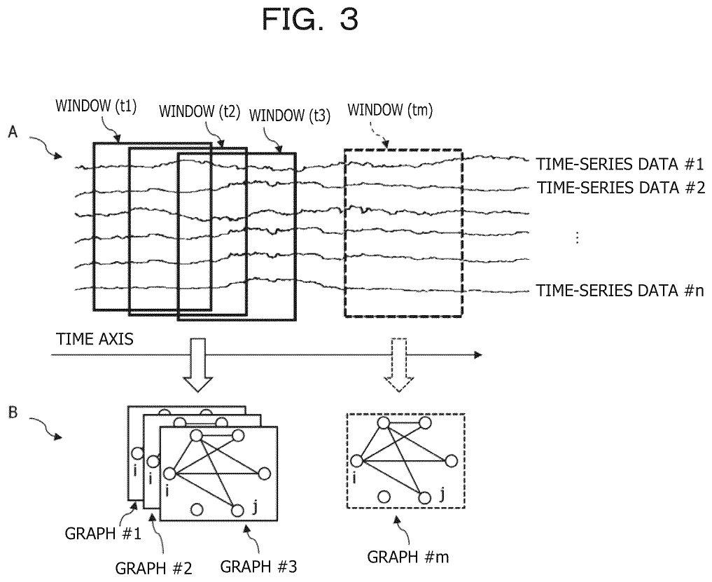

FIG. 3 is a diagram for explaining a graph in the detection device 1 as an example of the embodiment.

In FIG. 3, the reference sign A depicts an example of a plurality of (n) pieces of time-series data #1 to #n, and the reference sign B depicts an example of a plurality of (m) graphs #1 to #m generated based on the time-series data indicated by the reference sign A.

The graph has a plurality of vertices (nodes) and a side (edge) representing a relationship between this plurality of vertices. Each vertex corresponds to one piece of time-series data. In addition, the side represents a relationship between this plurality of vertices (between pieces of time-series data) by a coupling state between the vertices (for example, whether or not the vertices are linked with each other). In the example illustrated in FIG. 3, each graph is an undirected graph.

The graph creation unit 2 cuts out parts of the plurality of pieces of time-series data arranged such that the lapse of time coincides, in a rectangular region such that individual parts for each piece of time-series data are included, and creates a graph based on each piece of time-series data included in this rectangular region. The rectangular region for cutting out the time-series data may be referred to as a window. In the example indicated by the reference sign A attached in FIG. 3, the left-right direction in the drawing denotes a time axis direction, and indicates the elapsed time.

The graph creation unit 2 sets a plurality of windows while shifting the plurality of pieces of time-series data along the time axis direction. It is desirable that the length of the window in the direction along the time axis correspond to a unit time (time range) for creating the graph, and each of the plurality of windows have the same size (length in the time axis direction). The graph creation unit 2 creates one graph for one window.

The graph is constituted by a matrix obtained as a solution of an optimization problem, and the components of the matrix represent the strength of the relationship between the elements of the time-series data.

The graph creation unit 2 calculates a matrix for constructing the graph by solving the optimization problem from a plurality of pieces of time-series data included in the window. The optimization problem may be a graphical Lasso. The matrix constituting the graph is represented by a symbol ∧. The matrix ∧ is represented by following formula (1).

$$\begin{matrix}[ Mathematical Formula 1 ] & \\ Λ = ( \begin{matrix}{λ}_{11} & … & {λ}_{1 n} \\ ⋮ & ⋱ & ⋮ \\ {λ}_{n 1} & … & {λ}_{n n}\end{matrix} ) & ( 1 )\end{matrix}$$

In the matrix ∧ represented by above formula (1), λᵢⱼ=0 represents that data i and data j are independent of each other. On the other hand, the fact that λᵢⱼ=0 is not satisfied represents that there is a correlation between the data i and the data j.

The matrix ∧ is a matrix calculated by solving an optimization problem (graphical Lasso) about a precision matrix for a plurality of pieces of time-series data. The precision matrix is a matrix for constructing the graph and is an inverse matrix of a covariance matrix.

The graph creation unit 2 creates a graph based on the matrix ∧. The graph creation unit 2 represents a portion of the matrix ∧ having an element of λᵢⱼ=0 in the graph in such a manner that there is no side between a vertex i and a vertex j. In addition, a portion of the matrix ∧ not having an element of λᵢⱼ=0 is represented in the graph in such a manner that there is a side between the vertex i and the vertex j.

The partial correlation matrix creation unit 3 computes a partial correlation matrix ∧′ by applying a partial correlation to the matrix ∧. The partial correlation matrix ∧′ is represented by following formula (2).

$$\begin{matrix}[ Mathematical Formula 2 ] & \\ Λ ’ = ( \begin{matrix}{λ ’}_{11} & … & {λ ’}_{1 n} \\ ⋮ & ⋱ & ⋮ \\ {λ ’}_{n 1} & … & {λ ’}_{n n}\end{matrix} ) & ( 2 )\end{matrix}$$

Each element λ′ᵢⱼ of the partial correlation matrix ∧′ represents a partial correlation specified based on the matrix ∧. In the partial correlation matrix ∧′, the influence of a common factor in each element having a causal relationship with the data i and the data j is removed.

The calculation of the partial correlation matrix ∧′ by the partial correlation matrix creation unit 3 can be implemented using a known approach, and the description thereof will be omitted.

The partial correlation matrix creation unit 3 computes the partial correlation matrix ∧′ for each matrix ∧. The partial correlation matrix creation unit 3 stores information on the computed partial correlation matrix ∧′ in a predetermined storage area of the storage unit 10d, or the like.

The weighted graph creation unit 4 creates a weighted graph based on the partial correlation matrix ∧′ calculated by the partial correlation matrix creation unit 3. The weighted graph creation unit 4 generates data for constituting the weighted graph (weighted graph structure data) based on the partial correlation matrix ∧′.

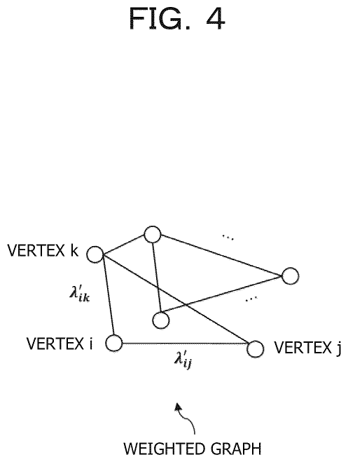

FIG. 4 is a diagram illustrating an example of a weighted graph in the detection device 1 as an example of the embodiment.

The weighted graph has a plurality of vertices (nodes) and a side (edge) representing a relationship between this plurality of vertices. Each vertex corresponds to one piece of time-series data. In addition, the side represents a relationship between this plurality of vertices (between pieces of time-series data) by a coupling state between the vertices (for example, whether or not the vertices are linked with each other). In addition, a weight representing a relationship between vertices is set for each side.

The weighted graph creation unit 4 creates a weighted graph by assuming the element λ′ᵢⱼ in the partial correlation matrix ∧′ as a weight of the side linking the vertex i and the vertex j.

The weighted graph creation unit 4 generates the weighted graph structure data for a plurality of pieces of time-series data, with the partial correlation specified based on the matrix ∧ calculated by solving the optimization problem (graphical Lasso) about the precision matrix for the plurality of pieces of time-series data, as the weight of the side in the graph.

The weighted graph has a simplified shape by extracting only sides having a strong relationship in the graph created by the graph creation unit 2 and can be said to be a graph in which a weight representing a relationship is set in each side.

The weighted graph creation unit 4 stores information on the created weighted graph in a predetermined storage area of the storage unit 10d, or the like.

The persistence diagram creation unit 5 creates a persistence diagram by applying persistence homology transformation to the weighted graph created by the weighted graph creation unit 4.

The persistence diagram creation unit 5 reflects the strength of the relationship between the vertices in the weighted graph, by applying persistent homology transformation using the super-level filtration, to create the persistence diagram.

The persistence diagram creation unit 5 performs persistent homology transformation on the weighted graph structure data, whereby the persistence diagram is obtained.

In the weighted graph, the number of sides reflected in the weighted graph increases by lowering a threshold value for the weight of the side, and the number of sides reflected in the weighted graph decreases by raising the threshold value. For example, in the weighted graph, the shape of the weighted graph after reflecting the threshold value changes by changing the threshold value for the weight of the side.

The persistence diagram creation unit 5 applies the persistent homology to the side in the weighted graph to create the persistent diagram.

The persistence diagram creation unit 5 creates the persistence diagram by plotting, as data points, an occurrence time point and a disappearance time point of a specified shape in the weighted graph caused by sequentially changing the threshold value for the weight of the side in the weighted graph in the persistent homology transformation for the weighted graph.

Note that the creation of the persistence diagram by the persistence diagram creation unit 5 can be implemented using a known approach, and the description thereof will be omitted.

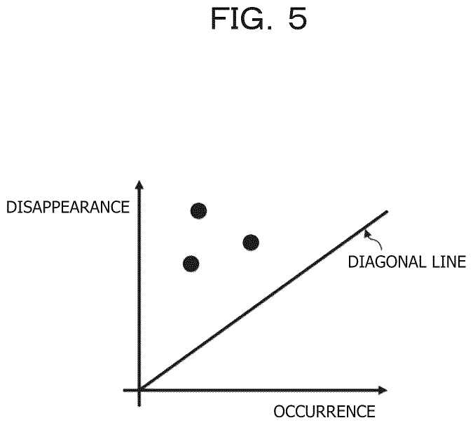

FIG. 5 is a diagram illustrating an example of a persistence diagram in the detection device 1 as an example of the embodiment.

In the persistence diagram, the occurrence and disappearance of the specified shape in the weighted graph caused by sequentially changing the threshold value for the weight of the side in the weighted graph are represented as data points.

As described above, the persistence diagram is created based on the weighted graph, and this weighted graph is created for each window cut out in a specified time range from the plurality of pieces of time-series data. Therefore, the plurality of persistence diagrams created based on the plurality of windows has a temporal anteroposterior relationship.

In addition, the persistence diagram creation unit 5 may create the persistence diagrams for the plurality of windows set in the plurality of pieces of time-series data in chronological order from the oldest one.

In the persistence diagram, data points far from the diagonal line are deemed to be vital features of data, and changes in the state of the system can be tracked by watching changes in the distribution of these data points.

The persistence diagram creation unit 5 stores information on the created persistence diagram in a predetermined storage area of the storage unit 10d, or the like.

The anomaly sign detection unit 6 detects a sign of an anomaly in the analysis object, based on the persistence diagrams created by the persistence diagram creation unit 5.

The anomaly sign detection unit 6 counts how many data points are present within the specified region (predetermined region) set at a position separated from the diagonal line by a predetermined distance in the persistence diagram and detects a sign of an anomaly based on the counted number. For example, the anomaly sign detection unit 6 may detect a sign of an anomaly based on a change in the number of data points within the specified region in the persistence diagram.

The specified region in the persistence diagram may have a circular shape in order to simplify arithmetic operations. Note that the shape of the specified region is not limited to the circle and can be appropriately altered and carried out. For example, the specified region may have a shape other than the circle, such as a rectangle, or alternatively, may have a belt-like shape placed in parallel with the diagonal line at a position with a predetermined distance interposed from the diagonal line.

The anomaly sign detection unit 6 may detect a sign of an anomaly based on a change in the number of data points within the specified regions in a plurality of persistence diagrams having a temporal anteroposterior relationship.

For example, for two consecutive (temporally successive) persistence diagrams in time series, the anomaly sign detection unit 6 may detect a sign of an anomaly when the number of data points within the specified region in the posterior persistence diagram decreases by a first threshold value or more as compared with the number of data points within the specified region in the anterior persistence diagram.

Here, the first threshold value may be a predetermined ratio (predetermined percentage value) to the number of data points within the specified region in the anterior persistence diagram. For example, the anomaly sign detection unit 6 may detect, as a sign of an anomaly, a case where the number of data points within the specified region in the posterior persistence diagram decreases by 30% or more with respect to the number of data points within the specified region in the anterior persistence diagram. In addition, the first threshold value may be a predefined fixed value and can be appropriately altered and carried out.

In addition, for two consecutive (temporally successive) persistence diagrams in time series, the anomaly sign detection unit 6 may detect an anomaly when the number of data points within the specified region in the posterior persistence diagram decreases by a second threshold value or more as compared with the number of data points within the specified region in the anterior persistence diagram. The second threshold value is a value higher than the first threshold value.

Furthermore, the anomaly sign detection unit 6 may detect a sign of an anomaly by comparing the number of data points within the specified region in the persistence diagram with a third threshold value and may detect an anomaly when the number of data points within the specified region in the persistence diagram is equal to or more than the third threshold value.

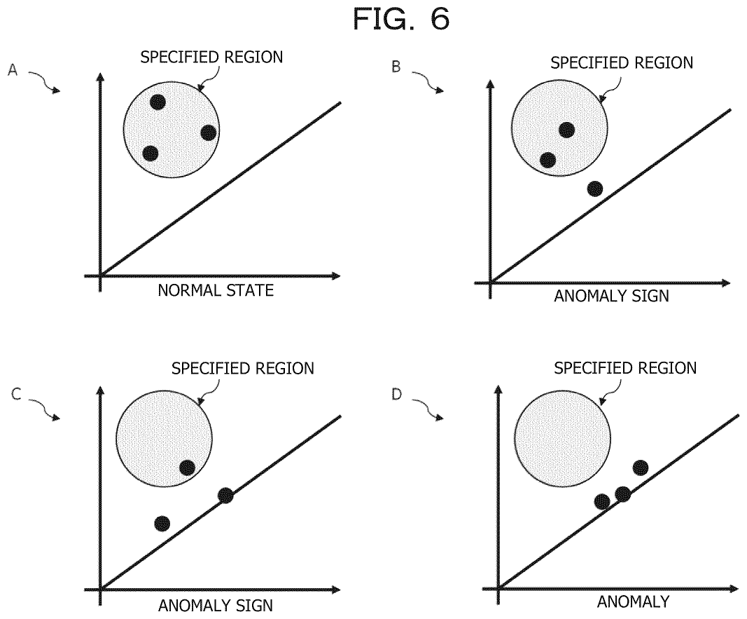

FIG. 6 is a diagram for explaining processing by the anomaly sign detection unit 6 of the detection device 1 as an example of the embodiment.

In this FIG. 6, the reference signs A, B, C, and D each indicate the persistence diagram, where the reference sign A indicates a normal state and the reference sign D indicates an anomalous state. In addition, the reference signs B and C indicate anomaly sign states.

In each of these persistence diagrams depicted as examples in FIG. 6, the black circles denote data points representing the occurrence and disappearance of the specified shape in the weighted graph. In addition, each of these persistence diagrams indicates an example in which the specified region is circular.

In the normal state indicated by the reference sign A, all the three data points are located within the specified region. On the other hand, in the anomalous state indicated by the reference sign D, all the three data points are located outside the predetermined region.

In the anomaly sign state indicated by the reference sign B, one data point of the three data points falls outside the specified region, and in the anomaly sign state indicated by the reference sign C, two data points of the three data points fall outside the specified region.

Here, for example, it is assumed that the persistence diagram indicated by the reference sign B has been created when the window from which the persistence diagram indicated by the reference sign B has been derived follows, on the time axis, the window from which the persistence diagram indicated by the reference sign A has been derived, which is after the persistence diagram indicated by the reference sign A.

In such a case, it is understood that one data point has fallen outside the specified region as illustrated in the persistence diagram of the reference sign B, and the number of data points within the specified region is decreased by about 33% from the state in which the three data points have been located within the specified region as illustrated in the persistence diagram of the reference sign A.

The anomaly sign detection unit 6 verifies that the number of data points (two) within the specified region in the posterior persistence diagram (see the reference sign B in FIG. 6) has decreased by the first threshold value (such as 30%) or more with respect to the number of data points (three) within the specified region in the anterior persistence diagram (see the reference sign A in FIG. 6) and detects a sign of an anomaly.

In addition, for example, it is assumed that the persistence diagram indicated by the reference sign C has been created when the window from which the persistence diagram indicated by the reference sign C has been derived follows, on the time axis, the window from which the persistence diagram indicated by the reference sign A has been derived, which is after the persistence diagram indicated by the reference sign A.

In such a case, it is understood that two data points have fallen outside the specified region as illustrated in the persistence diagram of the reference sign C, and the number of data points within the specified region is decreased by about 66% from the state in which the three data points have been located within the specified region as illustrated in the persistence diagram of the reference sign A.

The anomaly sign detection unit 6 verifies that the number of data points (one) within the specified region in the posterior persistence diagram (see the reference sign C in FIG. 6) has decreased by the first threshold value (such as 30%) or more with respect to the number of data points (three) within the specified region in the anterior persistence diagram (see the reference sign A in FIG. 6) and detects a sign of an anomaly.

In addition, in two consecutive persistence diagrams in time series, it can be said that a change in the number of data points within the specified region represents a degree (extent) of anomaly.

For example, for two consecutive persistence diagrams in time series, a case where the number of data points within the specified region in the posterior persistence diagram decreased from the number of data points within the specified region in the anterior persistence diagram is smaller (such as a case where the number of decreased data points is less than a predetermined threshold value) represents that the degree of anomaly is lower. In contrast to this, a case where the number of data points within the specified region in the posterior persistence diagram decreased from the number of data points within the specified region in the anterior persistence diagram is larger (such as a case where the number of decreased data points is equal to or more than a predetermined threshold value) represents that the degree of anomaly is higher.

The anomaly sign detection unit 6 determines the degree (extent) of anomaly based on distribution of data points in the specified regions in a plurality of persistence diagrams.

In addition, when detecting a sign of an anomaly, the anomaly sign detection unit 6 outputs a notification that a sign of an anomaly has been detected, to a user or the like.

For example, the anomaly sign detection unit 6 may cause the output device such as a monitor to display a message stating that a sign of an anomaly has been detected. In addition, the approach of notifying that a sign of an anomaly has been detected is not limited to this and can be appropriately altered and carried out.

In addition, in FIG. 6, for example, it is assumed that the persistence diagram indicated by the reference sign D has been created when the window from which the persistence diagram indicated by the reference sign D has been derived follows, on the time axis, the window from which the persistence diagram indicated by the reference sign A has been derived, which is after the persistence diagram indicated by the reference sign A.

In such a case, it is understood that all the three data points have fallen outside the specified region as illustrated in the persistence diagram of the reference sign D, and the number of data points within the specified region is decreased by 100% from the state in which the three data points have been located within the specified region as illustrated in the persistence diagram of the reference sign A.

The anomaly sign detection unit 6 verifies that the number of data points (zero) within the specified region in the posterior persistence diagram (see the reference sign D in FIG. 6) has decreased by the second threshold value (such as 80%) or more with respect to the number of data points (three) within the specified region in the anterior persistence diagram (see the reference sign A in FIG. 6) and detects an anomaly.

When detecting an anomaly, the anomaly sign detection unit 6 outputs a notification that an anomaly has been detected, to a user or the like.

For example, the anomaly sign detection unit 6 may cause the output device such as a monitor to display a message stating that an anomaly has been detected. In addition, the approach of notifying that an anomaly has been detected is not limited to this and can be appropriately altered and carried out.

### (B) Operation

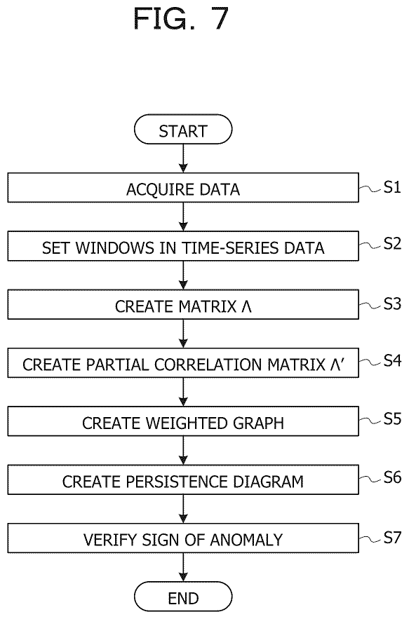

Processing of the detection device 1 as an example of the embodiment configured as described above will be described with reference to the flowchart (steps S1 to S7) illustrated in FIG. 7.

In step S1, the graph creation unit 2 reads a plurality of pieces of time-series data stored in the storage device 7.

In step S2, the graph creation unit 2 sets a plurality of windows while shifting the plurality of pieces of time-series data along the time axis direction.

In step S3, the graph creation unit 2 calculates the matrix ∧ for each window by solving the optimization problem (graphical Lasso) from a plurality of pieces of time-series data included in each window.

In step S4, the partial correlation matrix creation unit 3 computes the partial correlation matrix ∧′ by applying the partial correlation to the matrix ∧.

In step S5, the weighted graph creation unit 4 creates the weighted graph based on the partial correlation matrix ∧′ calculated by the partial correlation matrix creation unit 3.

In step S6, the persistence diagram creation unit 5 creates the persistence diagram by applying persistence homology to the weighted graph created by the weighted graph creation unit 4.

In step S7, the anomaly sign detection unit 6 verifies whether the analysis object has a sign of an anomaly, based on the persistence diagrams created by the persistence diagram creation unit 5. For example, the anomaly sign detection unit 6 detects a sign of an anomaly based on a change in the number of data points within the specified regions in a plurality of persistence diagrams having a temporal anteroposterior relationship. Thereafter, the processing ends.

### (C) Effects

As described above, according to the detection device 1 as an example of the embodiment, the weighted graph creation unit 4 generates a plurality of weighted graphs based on a plurality of graphs created by the graph creation unit 2 from a plurality of pieces of time-series data. Then, the persistence diagram creation unit 5 analyzes these weighted graphs using the persistent homology, whereby a change in the structures of the weighted graphs can be tracked and analyzed.

This may enable to represent a state or a change in a state of the analysis object (system) in detail and to also represent whether the state is changing to a normal state or an anomalous state. For example, by grasping a state change from normal to anomaly, the anomaly sign detection unit 6 can detect a sign of an anomaly, which may enable to detect an anomaly at an early stage and also to avoid a failure of the analysis object system beforehand. In addition, resource and financial damage caused by the failure of the analysis object system may be reduced.

As compared with the existing approach in which only a binary determination of either normal or anomaly is performed, a sign of an anomaly may be grasped, and the occurrence of an anomaly may be avoided in advance. Besides, an anomaly may be confirmed earlier and damage when an anomaly has actually happened may be lessened.

In addition, the persistence diagram creation unit 5 creates the persistence diagram by applying persistence homology to the weighted graph created by the weighted graph creation unit 4. This may enable to suppress erroneous detection by the noise tolerance of the persistence diagram even for an anomaly when noise is added to the time-series data.

### (D) Others

The disclosed technique is not limited to the embodiments described above, and various modifications may be carried out in a range without departing from the spirit of the present embodiments.

In addition, the present embodiments may be carried out and manufactured by those skilled in the art according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a detection program for causing a computer to execute a process comprising:
generating weighted graph structure data for a plurality of pieces of time-series data, with a partial correlation specified based on a matrix calculated by solving an optimization problem about a precision matrix for the plurality of pieces of time-series data, as a weight of a side in a graph; and
detecting a sign of an anomaly, based on distribution of data points in a predetermined region in a persistence diagram obtained by a persistent homology transformation for the weighted graph structure data.

2. The non-transitory computer-readable recording medium according to claim 1, wherein in the persistent homology transformation, the persistence diagram is obtained by plotting, as the data points, an occurrence time point and a disappearance time point of a specified shape in the weighted graph caused by sequentially changing a threshold value for the weight of the side in the weighted graph.

3. A detection method to be performed by a computer, the method comprising:
generating weighted graph structure data for a plurality of pieces of time-series data, with a partial correlation specified based on a matrix calculated by solving an optimization problem about a precision matrix for the plurality of pieces of time-series data, as a weight of a side in a graph; and
detecting a sign of an anomaly, based on distribution of data points in a predetermined region in a persistence diagram obtained by a persistent homology transformation for the weighted graph structure data.

4. The detection method according to claim 3, wherein in the persistent homology transformation, the persistence diagram is obtained by plotting, as the data points, an occurrence time point and a disappearance time point of a specified shape in the weighted graph caused by sequentially changing a threshold value for the weight of the side in the weighted graph.

5. A detection apparatus comprising:
a memory, and
a processor coupled to the memory and configured to:
generate weighted graph structure data for a plurality of pieces of time-series data, with a partial correlation specified based on a matrix calculated by solving an optimization problem about a precision matrix for the plurality of pieces of time-series data, as a weight of a side in a graph; and
detect a sign of an anomaly, based on distribution of data points in a predetermined region in a persistence diagram obtained by a persistent homology transformation for the weighted graph structure data.

6. The detection apparatus according to claim 5, wherein in the persistent homology transformation, the persistence diagram is obtained by plotting, as the data points, an occurrence time point and a disappearance time point of a specified shape in the weighted graph caused by sequentially changing a threshold value for the weight of the side in the weighted graph.
